(19) United States
(12) Patent Application Publication
(10) Pub. No.: US 2022/0219123 A1
(43) Pub. Date: Jul. 14, 2022

(54) FILTRATION MEMBRANE TREATMENT DEVICE, MEMBRANE FILTRATION DEVICE, AND FILTRATION MEMBRANE TREATMENT METHOD

(71) Applicant: Mitsubishi Electric Corporation, Tokyo (JP)

(72) Inventors: Eiji IMAMURA, Tokyo (JP); Nozomu YASUNAGA, Tokyo (JP); Seiji NODA, Tokyo (JP)

(73) Assignee: Mitsubishi Electric Corporation, Tokyo (JP)

(21) Appl. No.: 17/275,678

(22) PCT Filed: Oct. 2, 2018
(86) PCT No.: PCT/JP2018/036806

§ 371 Date: Dec. 8, 2021

(51) Int. Cl. B01D 65/08; B01D 65/02; B01D 67/00

(52) U.S. Cl. CPC B01D 65/08; B01D 65/02; B01D 67/0093; B01D 2323/50; B01D 2321/168; B01D 2321/18; B01D 2323/02; B01D 2321/02

(57) ABSTRACT

A filtration membrane treatment device which performs ozone treatment on a filtration membrane, the filtration membrane treatment device including: a first supply portion which supplies an ozone-containing fluid to the filtration membrane; a measurement portion which measures a measurement value based on a pressure to the filtration membrane; and a control portion which adjusts, on the basis of a change in the measurement value measured by the measurement portion, a supply amount of the ozone-containing fluid to be supplied by the first supply portion.

### TECHNICAL FIELD

The present disclosure relates to a filtration membrane treatment device, a membrane filtration device, and a filtration membrane treatment method that enable ozone treatment of a filtration membrane with a small variation.

### BACKGROUND ART

If a treatment-target liquid is subjected to separation by a filtration membrane, the filtration membrane may be clogged with impurities and microorganisms in water. Such clogging can be prevented by improving the water permeability of such a filtration membrane in treatment of the filtration membrane. As methods for improving the water permeability of a filtration membrane, there are methods such as a method in which a produced filtration membrane is chemically treated and hydrophilized.

For example, Patent Document 1 describes a method including: treating a polyvinylidene-based resin porous membrane with a base, and then treating the polyvinylidene-based resin porous membrane with an aqueous solution that contains hydrogen peroxide or ozone; and further treating the polyvinylidene-based resin porous membrane with an aqueous solution that contains at least one type of salt selected from among perchloric acid salts, perbromates, and periodic acid salts, to perform hydrophilization. Furthermore, for example, Patent Document 2 describes a method including stopping passage of ozone water if a difference in pressure reaches a predetermined value when a membrane module is being cleaned with the ozone water, to perform hydrophilization.

### CITATION LIST

### Patent Document

Patent Document 1: Japanese Laid-Open Patent Publication No. 2004-230280

Patent Document 2: Japanese Laid-Open Patent Publication No. 2004-249168

### SUMMARY OF THE INVENTION

### Problems to be Solved by the Invention

Conventional filtration membrane treatment devices and filtration membrane treatment methods involve: hydrophilizing a membrane under a certain fixed condition that, for example, the membrane is treated by being immersed for 100 hours in ozone water having a concentration of 10 ppm; and evaluating the degree of hydrophilization with use of, as an index of hydrophilization, the ratio between the permeation amount of pure water after hydrophilization and the permeation amount of pure water before hydrophilization. In this method, a membrane is hydrophilized under a fixed condition. Thus, this method takes into account neither the fact that there is an individual difference among membranes nor the fact that even identical polyvinylidene-based resin porous membranes have different characteristics depending on the manufacturer of the membranes. Therefore, a problem arises in that there is a variation in the degree of hydrophilization among membranes and appropriate treatment of the membranes cannot be efficiently performed.

The present disclosure has been made to solve the above problem, and an object of the present disclosure is to provide a filtration membrane treatment device, a membrane filtration device, and a filtration membrane treatment method that enable ozone treatment of a filtration membrane with a small variation.

### Solution to the Problems

A filtration membrane treatment device according to the present disclosure is a filtration membrane treatment device which performs ozone treatment on a filtration membrane, the filtration membrane treatment device including:

a first supply portion which supplies an ozone-containing fluid to the filtration membrane;

a measurement portion which measures a measurement value based on a pressure to the filtration membrane; and

a control portion which adjusts, on the basis of a change in the measurement value measured by the measurement portion, a supply amount of the ozone-containing fluid to be supplied by the first supply portion.

A membrane filtration device according to the present disclosure is a membrane filtration device which treats a treatment-target liquid with use of the above-described filtration membrane treatment device, the membrane filtration device including:

a storage tank which stores the treatment-target liquid and in which the filtration membrane is immersed; and

a transfer portion which transfers, to outside of the storage tank, the treatment-target liquid having been filtered by the filtration membrane, wherein

the control portion causes the transfer portion to stop and causes the first supply portion to supply the ozone-containing fluid to the filtration membrane immersed inside the storage tank.

A filtration membrane treatment method according to the present disclosure is a filtration membrane treatment method including:

a supply step of supplying an ozone-containing fluid to a filtration membrane;

a measurement step of measuring a measurement value based on a pressure to the filtration membrane; and

a control step of adjusting a supply amount of the ozone-containing fluid on the basis of a change in the measurement value.

### Effect of the Invention

The filtration membrane treatment device, the membrane filtration device, and the filtration membrane treatment method according to the present disclosure enable ozone treatment of a filtration membrane with a small variation.

### BRIEF DESCRIPTION OF THE DRAWINGS

FIG. 1 is a diagram showing a configuration of a filtration membrane treatment device according to embodiment 1.

FIG. 2 is a flowchart of a filtration membrane treatment method by the filtration membrane treatment device shown in FIG. 1.

FIG. 3 is a diagram showing a configuration of another filtration membrane treatment device according to embodiment 1.

FIG. 4 is a diagram showing a configuration of another filtration membrane treatment device according to embodiment 1.

FIG. 5 is a diagram showing a configuration of another filtration membrane treatment device according to embodiment 1.

FIG. 6 is a diagram showing a configuration of another filtration membrane treatment device according to embodiment 1.

FIG. 7 is a diagram showing a configuration of another filtration membrane treatment device according to embodiment 1.

FIG. 8 is a diagram showing a configuration of a filtration membrane treatment device according to embodiment 2.

FIG. 9 is a diagram showing a configuration of another filtration membrane treatment device according to embodiment 2.

FIG. 10 is a diagram showing a configuration of a filtration membrane treatment device according to embodiment 3.

FIG. 11 is a flowchart of a filtration membrane treatment method by the filtration membrane treatment device shown in FIG. 10.

FIG. 12 is a diagram showing a configuration of another filtration membrane treatment device according to embodiment 3.

FIG. 13 is a diagram showing a configuration of a membrane filtration device in which a filtration membrane treatment device is used, according to embodiment 4.

FIG. 14 is a table showing the specifications of filtration membrane treatment devices used in Example 1, Comparative Example 1, and Comparative Example 2.

FIG. 15 is a table showing results of Example 1.

FIG. 16 is a table showing results of Comparative Example 1 and Comparative Example 2.

### DESCRIPTION OF EMBODIMENTS

### Embodiment 1

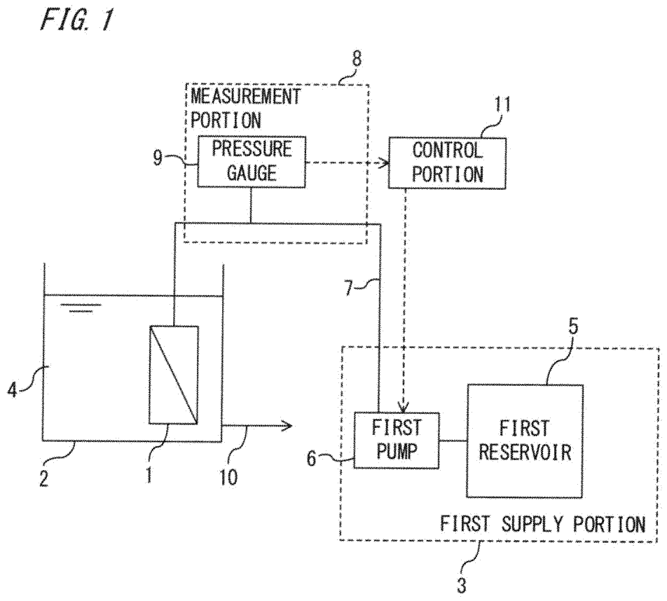

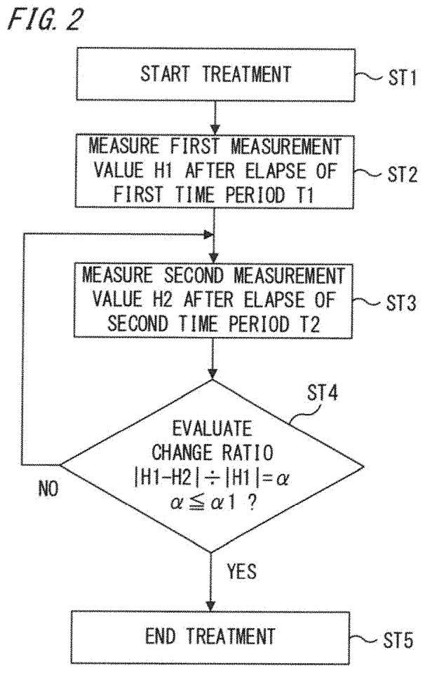

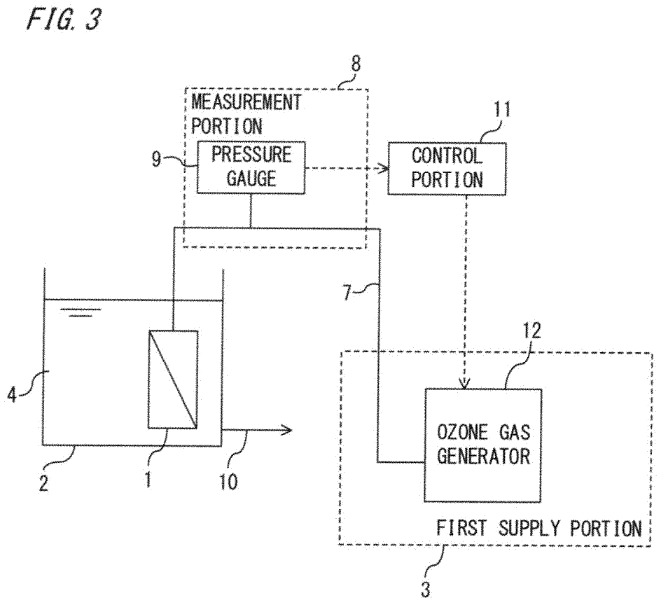

FIG. 1 is a diagram showing a configuration of a filtration membrane treatment device according to embodiment 1. FIG. 2 is a flowchart of a filtration membrane treatment method by the filtration membrane treatment device shown in FIG. 1. FIG. 3 to FIG. 7 are diagrams showing configurations of other filtration membrane treatment devices according to embodiment 1. In each drawing, the filtration membrane treatment device is for performing ozone treatment on a filtration membrane 1 to purge the filtration membrane 1 having treated a treatment-target liquid, thereby using the filtration membrane 1 for treatment of the treatment-target liquid again.

Thus, the filtration membrane 1 is inevitably formed of a material having ozone resistance. In addition, the filtration membrane 1 is formed of a material that is hydrophilized by ozone. Specifically, it is possible to use, for example, a material formed of a fluorine-based macromolecule. Representative examples of the material are polyvinylidene difluoride (PVDF) and polytetrafluoroethylene (PTFE).

The shape of the filtration membrane 1 is not particularly limited, and, for example, a hollow fiber membrane, a flat membrane, or a tubular membrane can be used. In addition, a module type of the filtration membrane 1 is not particularly limited, and, for example, an internal pressure type module or an external pressure type module accommodated in a cylindrical container, or an immersion type module, can be used. Here, description will be given with an example in which a hollow fiber membrane module of an immersion type is used.

The filtration membrane treatment device includes a first supply portion 3, a measurement portion 8, and a control portion 11. The first supply portion 3 supplies an ozone-containing fluid to the filtration membrane 1. The measurement portion 8 measures a measurement value H based on a pressure to the filtration membrane 1. The control portion 11 adjusts, on the basis of a change in the measurement value H measured by the measurement portion 8, a supply amount of the ozone-containing fluid to be supplied by the first supply portion 3.

Here, the filtration membrane 1 is a hollow fiber membrane module of an immersion type and thus filters the treatment-target liquid from a primary side to a secondary side. In addition, since a hollow fiber membrane module of an immersion type is used as the filtration membrane 1, the ozone-containing fluid will be described using an example of a pouring method similar to so-called “reverse-pressure cleaning” in which the ozone-containing fluid is poured from the secondary side toward the primary side.

The filtration membrane 1 is accommodated inside the accommodating tank 2. The accommodating tank 2 is filled with a liquid 4 which is, for example, water. Thus, the filtration membrane 1 is immersed in the liquid 4. This is because the filtration membrane 1 is a hollow fiber membrane module of an immersion type and performance deterioration thereof due to drying has to be prevented. Therefore, a filtration membrane 1 in which performance deterioration due to drying does not occur does not necessarily need to be subjected to ozone treatment in a state of being immersed in the liquid 4 inside the accommodating tank 2.

The filtration membrane 1, the measurement portion 8, and the first supply portion 3 are connected by a first pipe 7. The first supply portion 3 includes: a first reservoir 5 which stores the ozone-containing fluid; and a first pump 6 which is for supplying ozone from the first reservoir 5 through the first pipe 7 to the filtration membrane 1. As for the ozone-containing fluid, for example, use of one or more types of ozone gas, ozone water produced by dissolving ozone in a solvent such as water, or mixed water obtained by mixing, with ozone water, a substance that promotes generation of radicals due to decomposition of ozone, is assumed.

The measurement portion 8 includes, as a constituent for measuring the measurement value H based on the pressure to the filtration membrane 1, a pressure gauge 9 which measures a pressure value in the first pipe 7 as a pipe through which the fluid (here, ozone-containing fluid) to be supplied to the filtration membrane 1 flows. The specifications of the pressure gauge 9 is not limited as long as the pressure gauge 9 is of a type that allows the measured pressure value to be sent to the control portion 11. The control portion 11 receives the measurement value H from the pressure gauge 9 of the measurement portion 8 and controls, by means of the first pump 6, the supply amount of the ozone-containing fluid to be supplied through the first pipe 7, on the basis of a change in the measurement value H. The accommodating tank 2 is provided with a first discharge portion 10 by which an excess portion of the ozone-containing fluid or the liquid 4 is discharged to outside.

Next, a filtration membrane treatment method by the filtration membrane treatment device according to embodiment 1 configured as described above, will be described. First, the filtration membrane treatment device according to the present embodiment 1 is configured as described above, and the change in the measurement value H based on the pressure at the time of supplying the ozone-containing fluid to the filtration membrane 1 is observed so that the degree of ozone treatment is quantified and a timing of completion of ozone treatment is determined.

Regarding this, earnest studies by the present inventors led to the following findings. When the ozone-containing fluid is brought into contact with the filtration membrane 1, a hydrophilic functional group such as a hydroxyl group is added onto the molecular chain of the material that forms the filtration membrane 1 and that is hydrophilized by ozone. Thus, the hydrophilicity of the filtration membrane 1 is improved. Therefore, the water permeability (i.e., the easiness of passage of water) of the filtration membrane 1 is improved. Judging from this, it can be determined that the filtration membrane 1 is purged by ozone treatment.

The present inventors further found that, if the ozone-containing fluid is supplied to the filtration membrane 1 and ozone treatment of the filtration membrane 1 is monitored and evaluated on the basis of the change in the measurement value H based on the pressure, determination can be performed by interpretation as an index of the water permeability (the easiness of passage of water) of the filtration membrane 1. Moreover, the present inventors found that: if ozone treatment of the filtration membrane 1 is performed by supplying the ozone-containing fluid, the measurement value H based on the pressure to the filtration membrane 1 gradually decreases; and, if the ozone treatment is completed, the change in the measurement value H becomes very small. The reason for this was found to be as follows, as a result of earnest studies by the present inventors. There is a limit to the amount of a hydrophilic group that can be added onto the aforementioned molecular chain of the filtration membrane 1, and, if the limit is exceeded, the change in the degree of hydrophilization becomes very small even when the ozone-containing fluid is supplied to the filtration membrane 1.

Consequently, the present inventors found that determination based on the change in the measurement value H leads to decision of a breakpoint of the ozone treatment of the filtration membrane 1, i.e., a point at which the ozone treatment should be completed. As described above, the ozone treatment of the filtration membrane 1 is synonymous with hydrophilization of the filtration membrane 1. Therefore, the present inventors found a limit of the hydrophilization of the filtration membrane 1, i.e., a point at which the hydrophilization should be completed. It is noted that the above described findings apply also to the other embodiments, and description thereof is omitted, as appropriate.

Hereinafter, the filtration membrane treatment method will be described with reference to the flowchart in FIG. 2 in consideration of these findings. First, the control portion 11 drives the first pump 6, to perform a supply step of supplying the ozone-containing fluid from the first reservoir 5 of the first supply portion 3 through the first pipe 7 to the filtration membrane 1 (step ST1 in FIG. 2). It is noted that the ozone-containing fluid continues to be supplied such that the supply amount thereof is a fixed amount.

Next, a measurement step of measuring the measurement value H based on the pressure to the filtration membrane 1, is performed while the supply step is continued. First, the measurement portion 8 measures, as the measurement value H, a first measurement value H1 after the first supply portion 3 supplies the ozone-containing fluid for a first time period T1, and the measurement portion 8 sends the first measurement value H1 to the control portion 11 (step ST2 in FIG. 2). Then, a second measurement value H2 after the ozone-containing fluid is supplied for a second time period T2 which is longer than the first time period T1, is measured and sent to the control portion 11 (step ST3 in FIG. 3).

Preferable ranges of the first time period T1 and a time period from the end of the first time period T1 to the start of the second time period T2, for the measurement performed as described above, are 1 minute to 20 minutes. If the time periods are shorter than 1 minute, ozone treatment has hardly progressed, and the difference from a previous measurement value H or from an initial-state value is unclear, whereby there is a possibility that completion of the ozone treatment cannot be determined. Meanwhile, if the time periods are longer than 20 minutes, the time period to the next measurement is elongated, whereby there is a possibility that, even though the ozone treatment has actually been completed, determination of the completion is delayed and the ozone treatment is unnecessarily continued. It is noted that the first time period T1 and the time period from the end of the first time period T1 to the start of the second time period T2 may be equal to each other or may be individually set. For example, it can also be assumed that: each time period is initially set to be long at the start of the ozone treatment; and the time period is set to be short at approximation to a time point at which the treatment is ordinarily considered to end.

Then, a control step of adjusting the supply amount of the ozone-containing fluid on the basis of a change in the measurement value H, is performed. The control portion 11 determines whether or not a change ratio α in the following expression 1 between the first measurement value H1 and the second measurement value H2 is equal to or smaller than a threshold value α1 (the following expression 2) (step ST4 in FIG. 2).

|H1−H2|÷|H1|=α expression 1

α≤α1 expression 2

If the change ratio α is equal to or smaller than the threshold value α1 (YES), the supply of the ozone-containing fluid by the first supply portion 3 is suppressed. Here, the control portion 11 causes the first pump 6 to stop, to end the supply of the ozone-containing fluid to the filtration membrane 1 (step ST5 in FIG. 2).

Meanwhile, if the change ratio α is larger than the threshold value α1 (NO), the supply of the ozone-containing fluid by the first supply portion 3 is continued, and the process from step ST3 is repeated. If the operation is repeated from step ST3, the previously measured second measurement value H2 at the elapse of the second time period T2 is regarded as a first measurement value H1 at the elapse of the first time period T1 for the repetition. Then, a second measurement value H2 at the subsequent elapse of the second time period T2, is newly measured, and the method described above is repeated. That is, the first measurement value H1 at the elapse of the first time period T1 is the previous measurement value H, and the second measurement value H2 at the elapse of the second time period T2 is the present measurement value H.

A preferable range of the threshold value α1 for the change ratio α is 0 to 0.5. If the threshold value α1 is larger than 0.5, there is a possibility that ozone treatment is determined to have been completed even though there is room for the ozone treatment to progress.

In the above-described embodiment 1, an example in which the pressure value in the first pipe 7 is used as the measurement value H has been described. However, the present disclosure is not limited to this example. For example, the trans-membrane pressure (TMP) value between the primary side and the secondary side of the filtration membrane 1 may be measured and used as the measurement value H. In this case, for example, pressure gauges may be disposed respectively on the primary side and the secondary side of the filtration membrane 1, and a trans-membrane pressure value may be calculated from the values at the pressure gauges and used as the measurement value H. Alternatively, if a filtration membrane 1 of an immersion type such as one in FIG. 1 is used, a TMP may be calculated from a liquid level inside the accommodating tank 2 and the pressure value at the pressure gauge 9 and used as the measurement value H.

In addition, in the above-described embodiment 1, an example in which the first supply portion 3 includes the first reservoir 5 for storing the ozone-containing fluid and supplies the ozone-containing fluid, has been described. Although the ozone-containing fluid has not been particularly described, another case can be assumed in which ozone gas is used as the ozone-containing fluid. As shown in FIG. 3, a first supply portion 3 includes an ozone gas generator 12. The control portion 11 controls the amount of ozone gas to be generated from the ozone gas generator 12. The ozone gas is supplied through the first pipe 7 directly to the filtration membrane 1, whereby the filtration membrane can be treated in the same manner as in the above-described embodiment 1.

In the case where ozone gas is used as the ozone-containing fluid, the concentration of the ozone gas is preferably 1 ppm to 1000 ppm. The reason is as follows. If the concentration of the ozone gas is lower than 1 ppm, the ozone treatment effect is low and it takes time to complete ozone treatment. Meanwhile, if the concentration of the ozone gas is higher than 1000 ppm, a member forming the filtration membrane 1, the first pipe 7, or the like may be degraded.

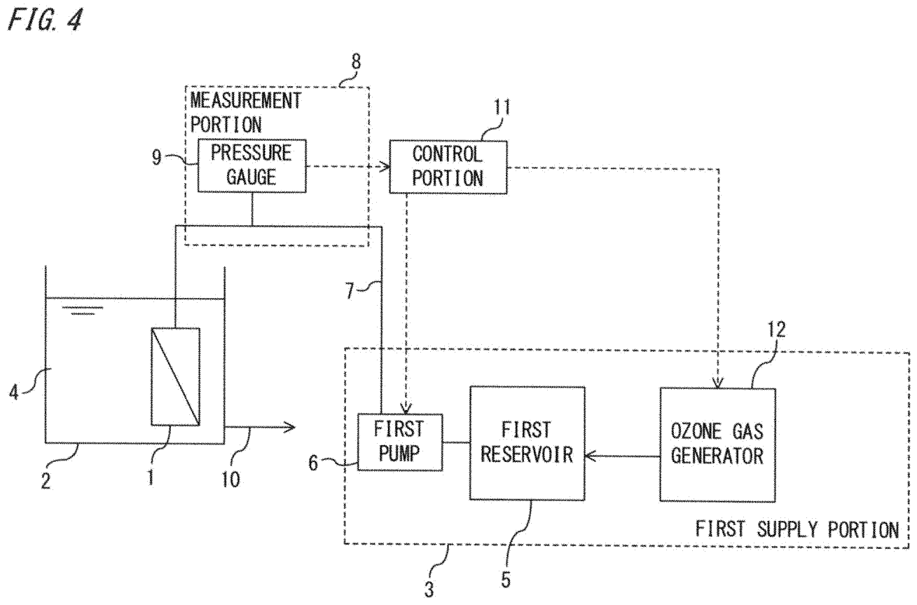

Another example of using ozone gas is shown in FIG. 4 in which a first supply portion 3 includes the ozone gas generator 12, the first reservoir 5, and the first pump 6. The control portion 11 controls the amount of ozone gas to be generated from the ozone gas generator 12. The generated ozone gas is stored as an ozone-containing fluid in the first reservoir 5, and the stored ozone gas is supplied via the first pump 6 to the filtration membrane 1, whereby the filtration membrane can be treated in the same manner as in the above-described embodiment 1. In this case, the inside of the first reservoir 5 may be filled with a porosity such as silica gel as an adsorbent so that the ozone gas is stored while being adsorbed and condensed.

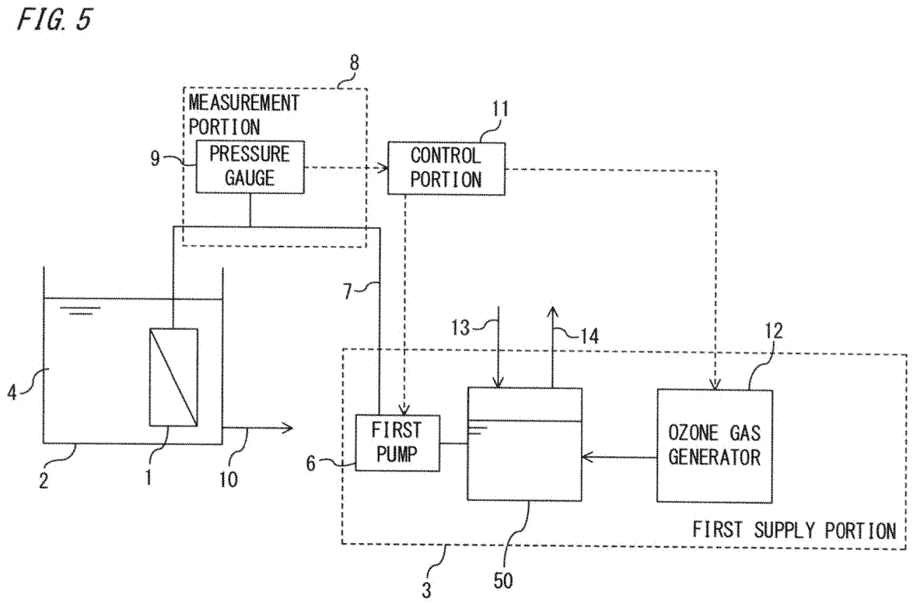

As another example, a case can be assumed in which ozone water is used as the ozone-containing fluid. As shown in FIG. 5, a first supply portion 3 includes the ozone gas generator 12, a first reservoir 50, and the first pump 6. The first reservoir 50 includes: a second pipe 13 through which a solvent such as water for dissolving ozone gas is supplied; and a second discharge portion 14 by which excess ozone gas in the first reservoir 5 is discharged to outside. Through the second pipe 13, for example, water is supplied to the first reservoir 50. Then, ozone gas is supplied from the ozone gas generator 12 into the first reservoir 50, and ozone water is produced and stored in the first reservoir 5. The stored ozone water is supplied via the first pump 6 to the filtration membrane 1, whereby the filtration membrane can be treated in the same manner as in the above-described embodiment 1.

In the case where ozone water is used as the ozone-containing fluid, the concentration of the dissolved ozone contained in the ozone water to be supplied to the filtration membrane 1 is preferably 1 mg/L to 100 mg/L. The reason is as follows. If the concentration of the dissolved ozone is lower than 1 mg/L, the ozone treatment effect is low and it takes time to complete the treatment. Meanwhile, if the concentration of the dissolved ozone is higher than 100 mg/L, there is a possibility that a large amount of oxygen gas bubbles is generated owing to decomposition of ozone and hinder the supply of the ozone water to the filtration membrane 1.

In the case where ozone water is used as the ozone-containing fluid, a pH adjuster such as hydrochloric acid or sulfuric acid may be added to the ozone water. The pH of the ozone water to be supplied to the filtration membrane 1 is not particularly limited as long as the pH is within a range corresponding to the pH resistance of the filtration membrane 1. For example, in a case where polyvinylidene difluoride (PVDF) is used for the filtration membrane 1, any pH can be selected from between 1 pH to 14 pH as the pH of the ozone water.

As another example, a case can be assumed in which mixed water obtained by mixing, with ozone water, a substance that promotes generation of radicals due to decomposition of ozone (hereinafter, abbreviated as a promoter) is used as the ozone-containing fluid. In this case, the mixed water produced by mixing the ozone water and the promoter in advance is stored in the first reservoir 5 shown in FIG. 1, and the stored mixed water is supplied via the first pump 6 to the filtration membrane 1, whereby the filtration membrane can be treated in the same manner as in the above-described embodiment 1.

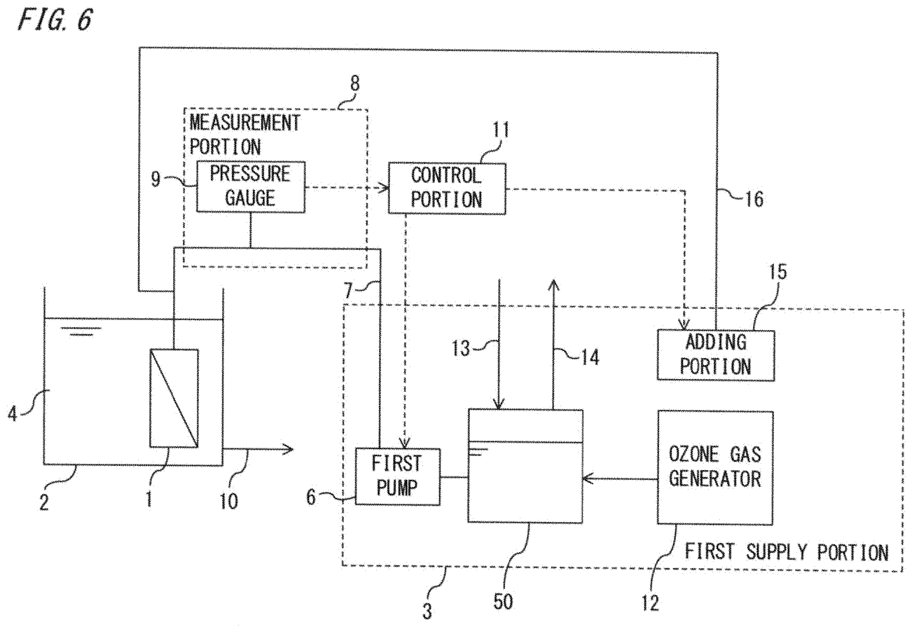

Another example of the case of using the mixed water is shown in FIG. 6 in which a first supply portion 3 includes the ozone gas generator 12, the first reservoir 50, the first pump 6, and an adding portion 15. The adding portion 15 is for adding the promoter. A third pipe 16 connecting the adding portion 15 and the first pipe 7 to each other is provided. The control portion 11 controls the amount of the promoter to be added by the adding portion 15.

The promoter is supplied from the adding portion 15 through the third pipe 16 to the first pipe 7, the promoter is mixed with the ozone water in the first pipe 7, and the obtained mixed water is supplied to the filtration membrane 1, whereby the filtration membrane can be treated in the same manner as in the above-described embodiment 1. As the promoter, for example, oxidizing agents such as hydrogen peroxide water and sodium hypochlorite and alkalis such as caustic soda and potassium hydroxide, can be used. Among them, one type may be selected, or a plurality of types may be used.

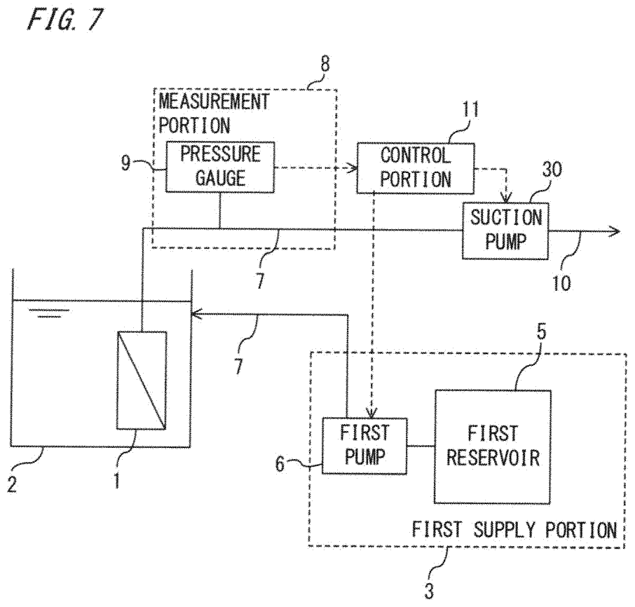

In the above-described embodiment 1, an example in which the first supply portion 3 pours the ozone-containing fluid from the secondary side to the primary side of the filtration membrane 1, has been described. However, the present disclosure is not limited to this example. An example in which the first supply portion 3 supplies the ozone-containing fluid from the primary side to the secondary side of the filtration membrane 1, will be described. As shown in FIG. 7, the ozone-containing fluid is supplied from the first pump 6 through the first pipe 7 to the accommodating tank 2. The ozone-containing fluid is suctioned via a suction pump 30 from the first pipe 7 connected to the filtration membrane 1, and the ozone-containing fluid is supplied to the filtration membrane 1, so that ozone treatment is performed on the filtration membrane 1. Then, the ozone-containing fluid suctioned via the suction pump 30 is discharged to outside by the first discharge portion 10. Also with this configuration, the filtration membrane can be treated in the same manner as in the above-described embodiment 1. It is noted that, in this case, the pressure value measured by the pressure gauge 9 is a negative value. However, since values are calculated with absolute values as indicated in the above-described expression 1, the calculation can be performed in the same manner.

The filtration membrane treatment device according to embodiment 1 configured as described above is a filtration membrane treatment device which performs ozone treatment on a filtration membrane, the filtration membrane treatment device including:

a first supply portion which supplies an ozone-containing fluid to the filtration membrane;

a measurement portion which measures a measurement value based on a pressure to the filtration membrane; and

a control portion which adjusts, on the basis of a change in the measurement value measured by the measurement portion, a supply amount of the ozone-containing fluid to be supplied by the first supply portion.

The filtration membrane treatment method according to embodiment 1 includes:

a supply step of supplying an ozone-containing fluid to a filtration membrane;

a measurement step of measuring a measurement value based on a pressure to the filtration membrane; and

a control step of adjusting a supply amount of the ozone-containing fluid on the basis of a change in the measurement value.

Thus, if the ozone-containing fluid is supplied to the filtration membrane and ozone treatment of the filtration membrane is monitored and evaluated on the basis of the change in the measurement value based on the pressure, determination can be performed by interpretation as an index of the water permeability (the easiness of passage of water) of the filtration membrane. Consequently, the point of completion of ozone treatment of the filtration membrane can be determined according to improvement in the water permeability due to progression of hydrophilization of the filtration membrane. Therefore, hydrophilization potential latently belonging to the filtration membrane is maximized, and ozone treatment can be assuredly completed regardless of a variation based on an individual difference dependent on the types, the properties, or manufacturing of filtration membranes.

The filtration membrane filters a treatment-target liquid from a primary side to a secondary side, and

the first supply portion is configured to either pour the ozone-containing fluid from the secondary side to the primary side of the filtration membrane, or suction or inject the ozone-containing fluid from the primary side to the secondary side of the filtration membrane. Thus, ozone treatment can be performed according to the configuration of the filtration membrane.

The measurement portion measures, as the measurement value, each of a first measurement value H1 after the first supply portion supplies the ozone-containing fluid for a first time period and a second measurement value H2 after the supply is performed for a second time period which is longer than the first time period.

The control portion causes the first supply portion to continue the supply of the ozone-containing fluid if a change ratio a in expression 1 between the first measurement value H1 and the second measurement value H2 is equal to or smaller than a threshold value al, and causes the first supply portion to suppress the supply of the ozone-containing fluid if the change ratio α is larger than the threshold value α1.

The measurement step includes measuring each of a first measurement value H1 after the ozone-containing fluid is supplied for a first time period and a second measurement value H2 after the supply is performed for a second time period which is longer than the first time period.

The control step includes: continuing the supply of the ozone-containing fluid if a change ratio α in expression 1 between the first measurement value H1 and the second measurement value H2 is equal to or smaller than a threshold value α1; and suppressing the supply of the ozone-containing fluid if the change ratio α is larger than the threshold value α1.

Thus, it is possible to more assuredly control ozone treatment of the filtration membrane on the basis of a change between the measurement values which are the first measurement value and the second measurement value based on the pressures to the filtration membrane.

The control portion causes the first supply portion to end the supply of the ozone-containing fluid if the change ratio α between the measurement values is larger than the threshold value α1. Thus, wasteful supply of the ozone-containing fluid can be reduced in ozone treatment of the filtration membrane.

The first supply portion supplies, as the ozone-containing fluid, at least one of ozone gas, ozone water obtained by dissolving ozone, or ozone-mixed water obtained by mixing, with ozone water, a substance that promotes generation of radicals due to decomposition of ozone. Thus, the filtration membrane can be assuredly subjected to ozone treatment.

Regarding the measurement value from the measurement portion, a pressure value in a pipe through which a fluid being supplied to the filtration membrane is flowing is measured as the measurement value, or a trans-membrane pressure value between inside and outside of the filtration membrane at a time of passage of the fluid through the filtration membrane is measured as the measurement value. Thus, the measurement value regarding the filtration membrane can be assuredly measured, whereby the filtration membrane can be assuredly subjected to ozone treatment.

The filtration membrane is formed of a material that is hydrophilized by ozone, and

the control portion determines a degree of hydrophilization of the filtration membrane on the basis of the change in the measurement value. Thus, the degree of hydrophilization can be determined through ozone treatment of the filtration membrane according to the configuration of the filtration membrane.

### Embodiment 2

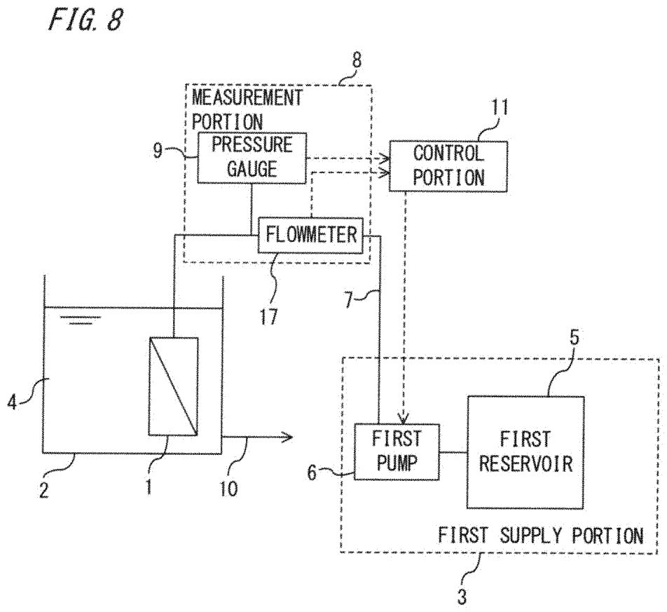

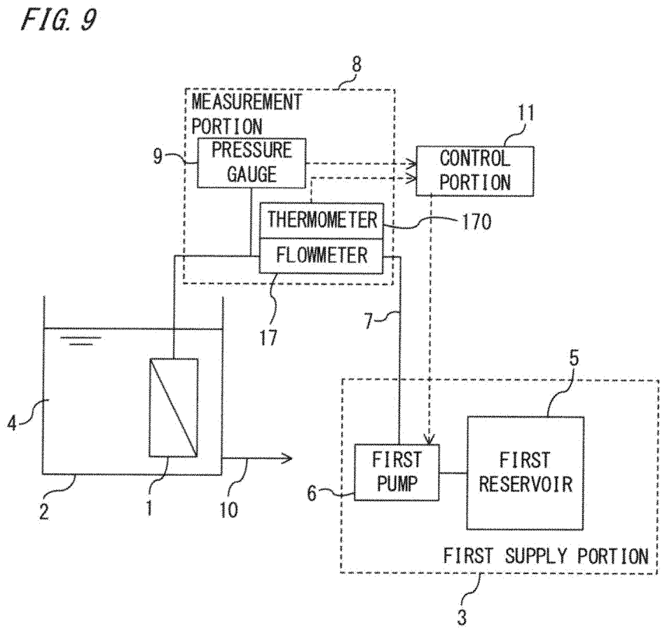

FIG. 8 and FIG. 9 are diagrams showing configurations of filtration membrane treatment devices according to embodiment 2. In the above-described embodiment 1, an example has been described in which the pressure value of the fluid in the first pipe 7 or the trans-membrane pressure (TMP) value of the filtration membrane 1 is used as the measurement value H based on the pressure to the filtration membrane 1. Meanwhile, in the present embodiment 2, a case will be described in which a value obtained in consideration of a flow rate value of the fluid in the first pipe 7 in addition to these measurement values is used as the measurement value H based on the pressure to the filtration membrane 1.

In the drawings, the same portions as those in the above-described embodiment 1 will be denoted by the same reference characters, and description thereof is omitted. A measurement portion 8 in FIG. 8 includes: the pressure gauge 9; and a flowmeter 17 provided to the first pipe 7. A measurement portion 8 in FIG. 9 includes: the pressure gauge 9; and the flowmeter 17 and a thermometer 170 provided to the first pipe 7. A filtration membrane treatment method by the filtration membrane treatment devices shown in FIG. 8 and FIG. 9 is performed according to the flowchart shown in FIG. 2 in the same manner as in the above-described embodiment 1. However, the filtration membrane treatment device shown in FIG. 8 according to the present embodiment 2 is different in that a value obtained by calculating the ratio between a pressure value in the first pipe 7 obtained by the pressure gauge 9 and a flow rate value in the first pipe 7 obtained by the flowmeter 17, is used as the measurement value H.

That is, in the present embodiment 2, the value calculated according to the following expression 3 is used as the measurement value H.

H=Q÷P expression 3

H: measurement value (L/h/kPa)

Q: flow rate value (L/h)

P: pressure value (kPa) or trans-membrane pressure value (kPa)

The filtration membrane treatment method is performed in the same manner as in the above-described embodiment 1 with use of this measurement value H.

If the effective area of the filtration membrane 1 is known, the value calculated according to the following expression 4 is used as the measurement value H.

H=Q÷A÷P expression 4

A: effective area of filtration membrane 1 (m2)

The filtration membrane treatment method is performed in the same manner as in the above-described embodiment 1 with use of this measurement value H.

Meanwhile, in the filtration membrane treatment device shown in FIG. 9 according to the present embodiment 2, a correction based on the temperature of the ozone-containing fluid in addition to the above-described flow rate value is applied to the measurement value H. Specifically, the measurement value H obtained according to the above-described expression 3 or the above-described expression 4 is subjected to a process as in the following expression 5, whereby a measurement value H′ after the correction is obtained.

H′=H×(μt÷μs) expression 5

H′: measurement value after correction based on temperature

μs: viscosity value of ozone-containing fluid at any reference temperature

μt: viscosity value of ozone-containing fluid at temperature at time of measurement of measurement value

It is noted that, in the case of using water as a solvent for ozone, the viscosity of the ozone-containing fluid is equal to the viscosity of the water, and thus the publicly-known viscosities of water can be used as μs and μt. In determining μs, a reference temperature needs to be arbitrarily selected but is not particularly limited. For example, the reference temperature may be set, as appropriate, to any normal temperature from 15° C. to 30° C. The filtration membrane treatment method is performed in the same manner as in the above-described embodiment 1 with use of this measurement value H′.

In each filtration membrane treatment device according to embodiment 2 configured as described above, the same advantageous effects as those in the above-described embodiment 1 are exhibited, as a matter of course, and in addition, regarding the measurement value from the measurement portion, a ratio between the pressure value or the trans-membrane pressure value and a flow rate value of the fluid being supplied to the filtration membrane is measured as the measurement value, and thus

a measurement value can be detected with excellent accuracy without being influenced by the flow rate of the ozone-containing fluid, whereby ozone treatment of the filtration membrane can be optimally controlled.

### Embodiment 3

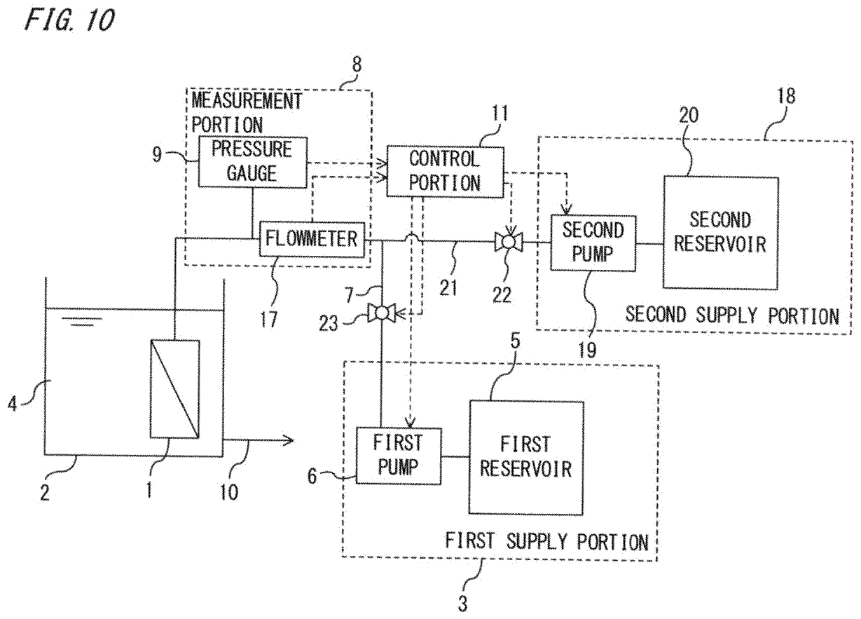

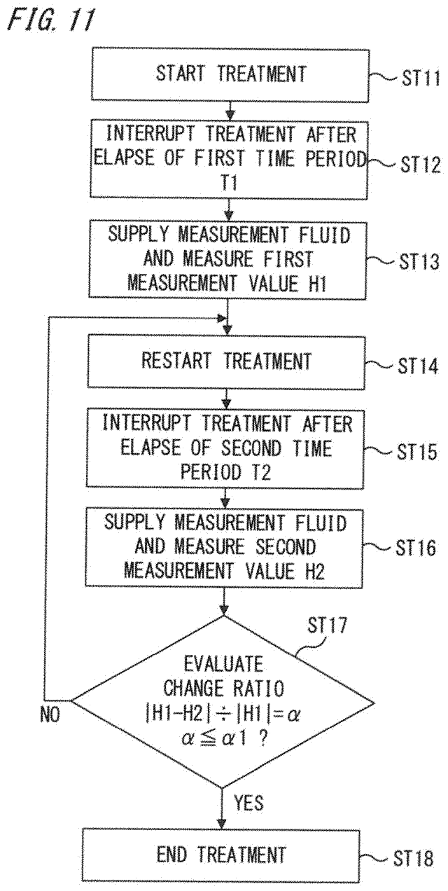

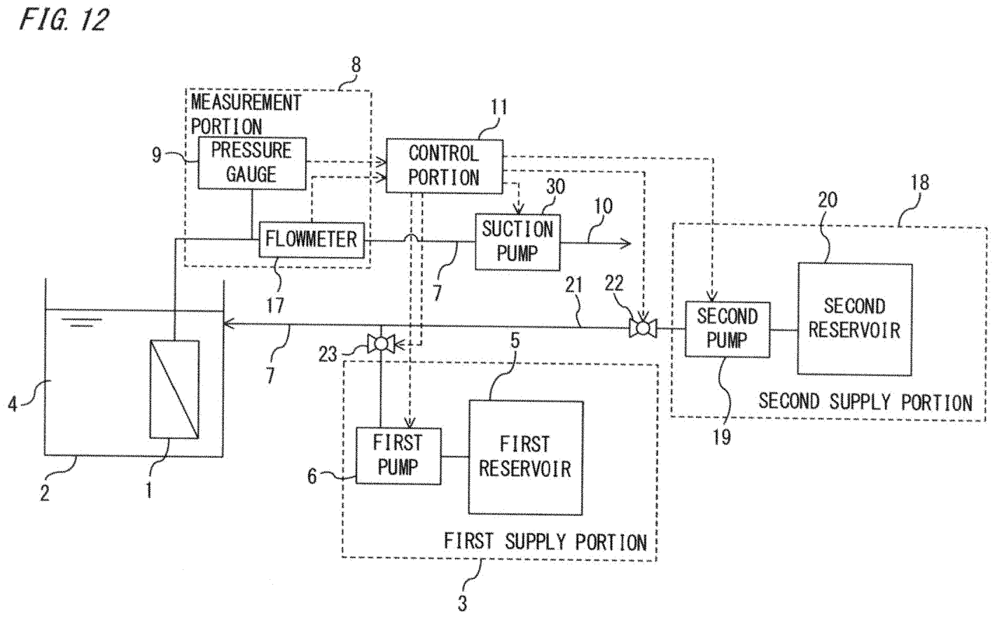

FIG. 10 is a diagram showing a configuration of a filtration membrane treatment device according to embodiment 3. FIG. 11 is a flowchart of a filtration membrane treatment method by the filtration membrane treatment device shown in FIG. 10. FIG. 12 is a diagram showing a configuration of another filtration membrane treatment device according to embodiment 3. In the drawings, the same portions as those in the above-described embodiments are denoted by the same reference characters, and description thereof is omitted. In the above-described embodiments, examples have been described in which the measurement value H based on the pressure to the filtration membrane 1 is measured while the ozone-containing fluid is being supplied to the filtration membrane 1. Meanwhile, in the present embodiment 3, a case will be described in which, when the measurement value H based on the pressure to the filtration membrane 1 is measured, the ozone-containing fluid to the filtration membrane 1 is temporarily stopped for the measurement.

In the drawings, the same portions as those in the above-described embodiments are denoted by the same reference characters, and description thereof is omitted. A second supply portion 18 which supplies a measurement fluid different from the ozone-containing fluid to the filtration membrane 1, is provided. The second supply portion 18 includes a second reservoir 20 and a second pump 19. The second reservoir 20 stores the measurement fluid. As long as the measurement fluid is different from the ozone-containing fluid, the measurement fluid is not particularly limited, and any fluid containing no substance that causes contamination of the filtration membrane 1 can be used. For example, use of tap water, pure water, ultrapure water, an alkaline chemical such as caustic soda, or an acidic chemical such as hydrochloric acid, sulfuric acid, or citric acid, is assumed.

The second pump 19 supplies the measurement fluid from the second reservoir 20 through a fourth pipe 21 to the first pipe 7 and the filtration membrane 1. The first pipe 7 is provided with a valve 23, and the fourth pipe 21 is provided with a valve 22.

When the measurement portion 8 measures the measurement value H, the control portion 11 causes the valve 23 of the first pipe 7 to close and causes the first pump 6 to stop, thereby causing the first supply portion 3 to stop the supply of the ozone-containing fluid. Meanwhile, the control portion 11 causes the valve 22 of the fourth pipe 21 to open and drives the second pump 19, thereby causing the measurement fluid to be supplied from the second reservoir 20 of the second supply portion 18 through the fourth pipe 21 to the first pipe 7 and the filtration membrane 1. When the measurement portion 8 ends measuring the measurement value H, the control portion 11 causes the valve 22 of the fourth pipe 21 to close and causes the second pump 19 to stop, thereby causing the second supply portion 18 to stop the supply of the measurement fluid. Meanwhile, the control portion 11 causes the valve 23 of the first pipe 7 to open and drives the first pump 6, thereby causing the ozone-containing fluid to be supplied from the first reservoir 5 of the first supply portion 3 through the first pipe 7 to the filtration membrane 1.

Next, the filtration membrane treatment method by the filtration membrane treatment device according to embodiment 3 configured as described above will be described with reference to the flowchart in FIG. 11. First, the control portion 11 drives the first pump 6, to perform a supply step of supplying the ozone-containing fluid from the first reservoir 5 of the first supply portion 3 through the first pipe 7 to the filtration membrane 1 (step ST11 in FIG. 11).

Then, after the supply is performed for the first time period T1, the control portion 11 causes the first pump 6 to stop and causes the valve 23 of the first pipe 7 to close, thereby causing the supply of the ozone-containing fluid to the filtration membrane 1 to stop and interrupting the ozone treatment of the filtration membrane 1 (step ST12 in FIG. 11). Then, the control portion 11 causes the valve 22 of the fourth pipe 21 to open and drives the second pump 19, thereby causing the measurement fluid to be supplied from the second reservoir 20 of the second supply portion 18 through the fourth pipe 21 to the first pipe 7 and the filtration membrane 1. Then, the measurement step of measuring the measurement value H based on the pressure to the filtration membrane 1 is performed while the measurement fluid continues to be supplied. The measurement portion 8 measures, as the measurement value H, a first measurement value H1 after the ozone-containing fluid is supplied to the filtration membrane 1 for the first time period T1, and the measurement portion 8 sends the first measurement value H1 to the control portion 11 (step ST13 in FIG. 11).

Then, the control portion 11 causes the second pump 19 to stop and causes the valve 22 of the fourth pipe 21 to close, thereby causing the supply of the measurement fluid to the filtration membrane 1 to stop. Meanwhile, the control portion 11 drives the first pump 6, thereby causing the ozone-containing fluid to be supplied from the first reservoir 5 of the first supply portion 3 through the first pipe 7 to the filtration membrane 1, whereby ozone treatment of the filtration membrane 1 is restarted (step ST14 in FIG. 11).

Then, after the supply is performed for the second time period T2, the control portion 11 causes the first pump 6 to stop and causes the valve 23 of the first pipe 7 to close, thereby causing the supply of the ozone-containing fluid to the filtration membrane 1 to stop and interrupting the ozone treatment of the filtration membrane 1 (step ST15 in FIG. 11). Then, the control portion 11 causes the valve 22 of the fourth pipe 21 to open and drives the second pump 19, thereby causing the measurement fluid to be supplied from the second reservoir 20 of the second supply portion 18 through the fourth pipe 21 to the first pipe 7 and the filtration membrane 1.

Then, the measurement step of measuring the measurement value H based on the pressure to the filtration membrane 1 is performed while the measurement fluid continues to be supplied. The measurement portion 8 measures, as the measurement value H, a second measurement value H2 after the ozone-containing fluid is supplied to the filtration membrane 1 for the second time period T2, and the measurement portion 8 sends the second measurement value H2 to the control portion 11 (step ST16 in FIG. 11). Then, the control step of adjusting the supply amount of the ozone-containing fluid on the basis of the change in the measurement value H is performed in the same manner as in the above-described embodiment 1 (step ST17 and step ST18 in FIG. 11).

In the above-described embodiment 3, at least the first pump 6 is stopped and the valve 23 is closed, whereby the supply of the hydrophilization fluid to the filtration membrane is stopped. In the case where, for example, ozone gas is supplied as the hydrophilization fluid, the ozone gas generator 12 may be stopped, or a bypass pipe or the like may be separately provided above the first pipe 7 and flow paths may be switched so that the supply of the ozone gas to the filtration membrane 1 is temporarily interrupted.

Also in the case where the first supply portion 3 supplies the ozone-containing fluid from the primary side to the secondary side of the filtration membrane 1 as shown in FIG. 7 for the above-described embodiment 1, measurement with the measurement fluid from the second supply portion 18 in the above-described embodiment 3 can be performed in the same manner. For example, as shown in FIG. 12, another filtration membrane treatment device according to embodiment 3 is configured by combining the configuration in FIG. 7 described in the above-described embodiment 1 and the configuration in FIG. 10 described in the present embodiment 3. That is, in the same manner as in the above-described embodiment 3, the control portion 11 causes the valve 22 of the fourth pipe 21 to open and drives the second pump 19, thereby causing the measurement fluid to be supplied from the second reservoir 20 of the second supply portion 18 through the fourth pipe 21 and the first pipe 7 to the accommodating tank 2.

Then, the measurement fluid is suctioned via the suction pump 30 from the first pipe 7 connected to the filtration membrane 1, and the measurement fluid suctioned via the suction pump 30 is discharged to outside by the first discharge portion 10. Also with this configuration, the filtration membrane treatment method can be performed in the same manner as in the above-described embodiment 3. It is noted that, in this case, the pressure value measured by the pressure gauge 9 is a negative value. However, since values with respect to pressure values are calculated with absolute values as indicated in the above-described expressions, the calculation can be performed in the same manner.

The filtration membrane treatment device according to embodiment 3 configured as described above exhibits the same advantageous effects as those in the above-described embodiments, as a matter of course, and in addition, includes

a second supply portion which supplies a measurement fluid which is different from the ozone-containing fluid to the filtration membrane, wherein

at a time of measurement by the measurement portion, the control portion causes the first supply portion to stop, causes the second supply portion to supply the measurement fluid to the filtration membrane, and causes the measurement portion to measure the measurement value. Consequently, if the measurement value is measured with use of the measurement fluid, no ozone treatment is performed on the filtration membrane during the measurement since the measurement fluid is different from the ozone-containing fluid. Thus, the measurement value can be stabilized, and a more accurate measurement value can be measured, whereby control of ozone treatment of the filtration membrane is further improved.

In addition, the filtration membrane filters a treatment-target liquid from a primary side to a secondary side, and

the second supply portion is configured to either pour the measurement fluid from the secondary side to the primary side of the filtration membrane, or suction or inject the measurement fluid from the primary side to the secondary side of the filtration membrane. Consequently, ozone treatment can be performed according to the configuration of the filtration membrane.

### Embodiment 4

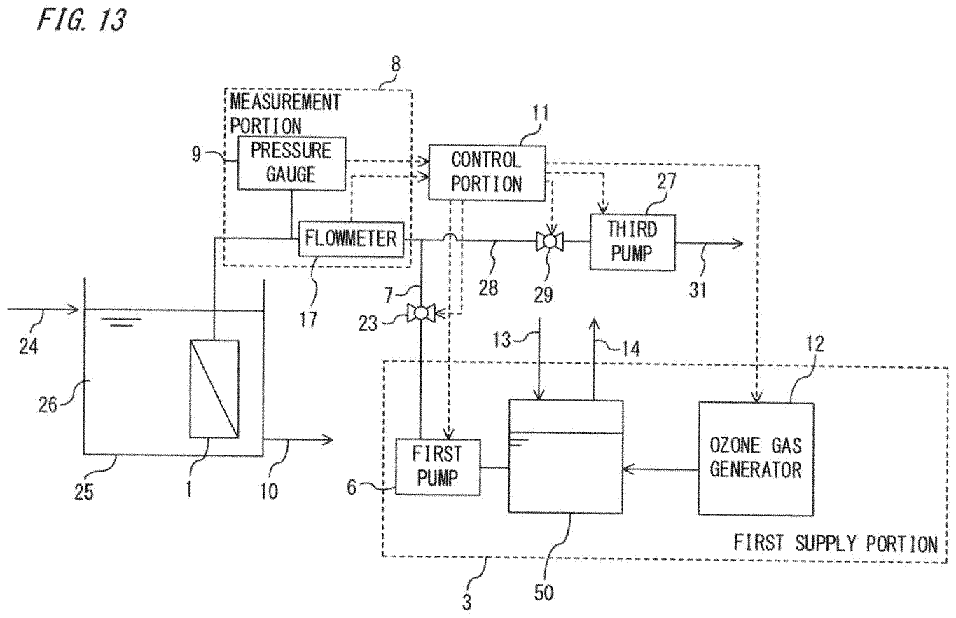

FIG. 13 is a diagram showing a configuration of a membrane filtration device in which a filtration membrane treatment device is used, according to embodiment 4. In the present embodiment 4, the filtration membrane 1 of any of the filtration membrane treatment devices according to the above-described embodiments is used for membrane filtration, and both filtration of a treatment-target fluid by the filtration membrane 1 and cleaning of the filtration membrane 1 can be performed. That is, if the filtration membrane 1 is contaminated by performing filtration such as waste water treatment or water cleaning treatment on the treatment-target liquid with use of the filtration membrane 1, the ozone-containing fluid is supplied to the filtration membrane 1, whereby dirt having adhered on the filtration membrane 1 can be separated and decomposed by the ozone-containing fluid. Thus, the filtration membrane 1 is hydrophilized while the filtration membrane 1 is cleaned.

As an example of this configuration, FIG. 13 shows a configuration in which the filtration membrane treatment device is incorporated in the membrane filtration device. In the drawing, the same portions as those in the above-described embodiments are denoted by the same reference characters, and description thereof is omitted. The membrane filtration device shown in FIG. 13 is, for example, a membrane separation bioreactor and includes: an aeration tank 25 as a storage tank which stores active sludge 26; and a fifth pipe 24 through which the treatment-target fluid is supplied to the active sludge 26 in the aeration tank 25. The aeration tank 25 functions also as the accommodating tank 2 of the above-described filtration membrane treatment devices. By the first discharge portion 10, an excess portion of the active sludge 26 in the aeration tank 25 is discharged. The first pipe 7 is connected to a sixth pipe 28, and the sixth pipe 28 is provided with a third pump 27 as a transfer portion. The sixth pipe 28 is provided with a valve 29. The third pump 27 is connected to a third discharge portion 31.

Next, an operation of the membrane filtration device according to embodiment 4 configured as described above will be described. First, the treatment-target liquid is supplied from the fifth pipe 24 to the aeration tank 25. Then, the active sludge 26 stored in the aeration tank 25 and the treatment-target liquid are mixed with each other. Organic matter contained in the treatment-target liquid is adsorbed and decomposed by the active sludge 26. At the same time, the control portion 11 causes the valve 29 to open, and the third pump 27 is driven. Then, the active sludge 26 is filtered by the filtration membrane 1. A filtered-out fluid obtained by the filtration is discharged through the first pipe 7 and the sixth pipe 28 to the outside of the device by the third discharge portion 31. At this time, the valve 23 of the first pipe 7 is in a closed state. The filtration operation does not necessarily need to be continuously performed but may be intermittently performed.

If dirt such as organic matter adheres on the filtration membrane 1 in association with the filtration operation, the trans-membrane pressure value of the filtration membrane 1 increases. Ozone treatment of the filtration membrane 1 is performed by stopping the filtration operation in a case where the trans-membrane pressure value reaches a predetermined value, in a case where the filtration is performed for a predetermined time period, or at an arbitrarily-selected timing.

The control portion 11 causes the third pump 27 to stop and causes the valve 29 to close, thereby ending the filtration operation. Then, the control portion 11 causes the valve 23 of the first pipe 7 to open and drives the first pump 6, thereby causing the ozone-containing fluid to be supplied to the filtration membrane 1, whereby the filtration membrane 1 is subjected to ozone treatment. The filtration membrane treatment method can be performed in the same manner as in the above-described embodiments, and thus description thereof is omitted, as appropriate. If the ozone treatment of the filtration membrane 1 is ended, the control portion 11 causes the first pump 6 to stop and causes the valve 23 of the first pipe 7 to close, whereby the treatment of the filtration membrane is ended. Then, the control portion 11 causes the valve 29 of the sixth pipe 28 to open and drives the third pump 27, whereby filtration treatment by the filtration membrane 1 is restarted.

It is noted that ozone treatment of the filtration membrane 1 does not need to be performed each time of cleaning of the filtration membrane 1, and instead, whether ozone treatment needs to be performed may be determined and ozone treatment may be performed each time it is determined that ozone treatment needs to be performed. Alternatively, filtration of the active sludge 26 may be started after ozone treatment is performed in advance before the start of filtration of the active sludge 26.

The membrane filtration device according to embodiment 4 configured as described above exhibits the same advantageous effects as those in the above-described embodiments, as a matter of course, and in addition, includes:

a storage tank which stores the treatment-target liquid and in which the filtration membrane is immersed; and

a transfer portion which transfers, to outside of the storage tank, the treatment-target liquid having been filtered by the filtration membrane, wherein

the control portion causes the transfer portion to stop and causes the first supply portion to supply the ozone-containing fluid to the filtration membrane immersed inside the storage tank. Thus, if the filtration membrane treatment device is incorporated in the membrane filtration device for the treatment-target liquid and both filtration by the filtration membrane and cleaning and hydrophilization of the filtration membrane are performed, the cleaning of the filtration membrane can be prevented from being excessively or insufficiently performed.

### EXAMPLE 1

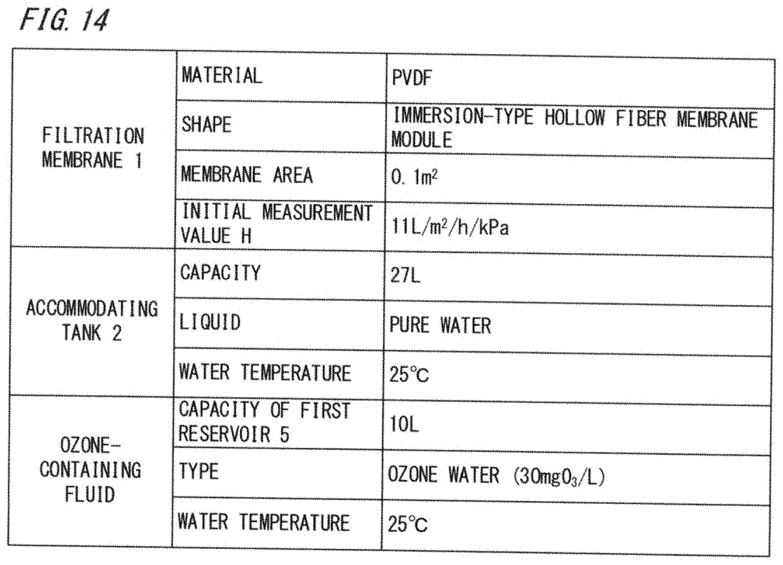

Hereinafter, Example 1 and Comparative Examples 1 and 2 will be described. Here, description will be given on the basis of results of performing ozone treatment on the filtration membrane 1 with use of the same device as the filtration membrane treatment device shown in FIG. 8. The main specifications of the filtration membrane treatment device used in the present Example 1 is as shown in the table in FIG. 14. In the present Example 1, before the start of ozone treatment, pure water was poured from the secondary side to the primary side of the filtration membrane 1 at 3 (L/h), and an initial measurement value H was obtained in advance with use of expression 4 on the basis of the flow rate value of the pure water, a pressure value at this time, and the effective area of the filtration membrane 1 (membrane area). Ozone treatment was performed according to the procedure of the flowchart shown in FIG. 2.

Ozone water was started to be supplied as the ozone-containing fluid to the filtration membrane 1 at 3 (L/h). Then, a first measurement value H1 regarding the filtration membrane 1 was measured after the elapse of 10 minutes which was the first time period T1. The first measurement value H1 was calculated with use of expression 4. Then, a second measurement value H2 was calculated after the elapse of the second time period T2 which was 10 minutes from the elapse of the first time period T1. Then, a change ratio a between the first measurement value H1 and the second measurement value H2 was calculated on the basis of expression 1 in a first determination. Here, the threshold value α1 was set as follows: α1=0.2. The change ratio α and the threshold value α1 were compared with each other with use of expression 2.

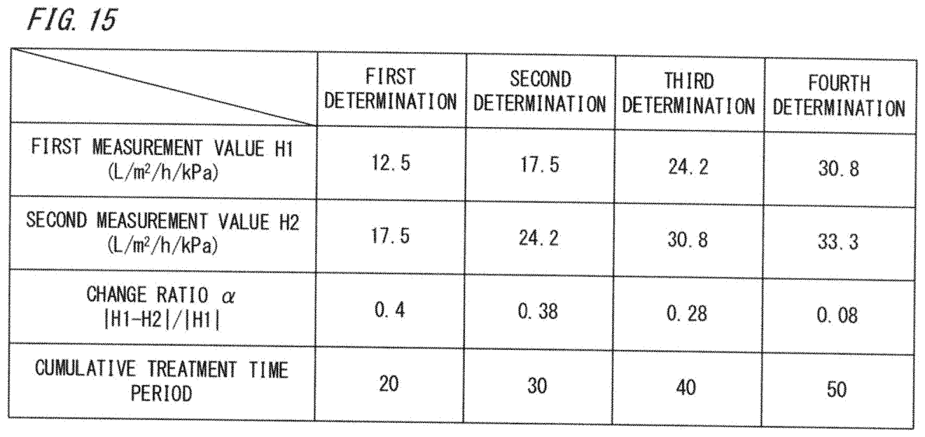

As shown in the table in FIG. 15, the change ratio α in the first determination was 0.4 and larger than the threshold value α1, i.e., 0.2. Thus, the measurement value H was measured again after the elapse of 10 minutes, and a second determination was performed in the same manner as the above-described first determination. In the second determination, the second measurement value H2 in the first determination was used as a first measurement value H1, and a second measurement value H2 after the elapse of the second time period T2, i.e., after the elapse of 30 minutes as a cumulative treatment time period from the start of the ozone treatment, was newly measured. The change ratio α at this time was 0.38 and larger the threshold value α1, i.e., 0.2. Thus, the measurement value H was measured again after the elapse of 10 minutes, and a third determination was performed in the same manner as the above-described determinations. The change ratio α in the third determination was 0.28. Thus, the measurement value H was measured again after the elapse of 10 minutes, and a fourth determination was performed in the same manner as the above-described determinations. The change ratio α in the fourth determination was 0.08 and equal to or smaller than the threshold value α1, i.e., 0.2. Thus, the ozone treatment was ended.

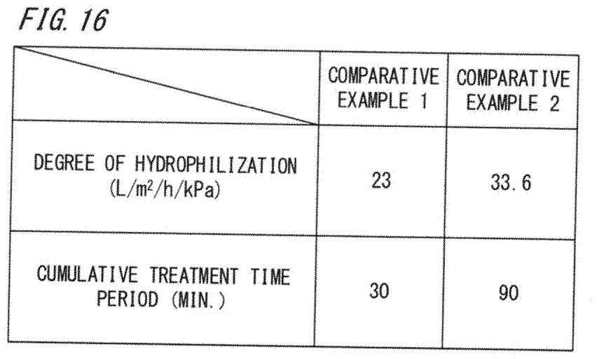

Meanwhile, in Comparative Example 1 shown in FIG. 16, the filtration membrane treatment device used in Example 1 was used, and ozone treatment of the filtration membrane was also performed under the same condition. In Comparative Example 1, a measurement value was obtained only at the time point at which 30 minutes of pouring of ozone water at 3 (L/h) as ozone treatment was ended. No measurement value was measured before the time point. Meanwhile, in Comparative Example 2 shown in FIG. 16, the filtration membrane was subjected to ozone treatment with use of the filtration membrane treatment device used in Example 1. In Comparative Example 2, hydrophilization merely involved 90 minutes of pouring of ozone water at 3 (L/h), and no measurement value was measured before the elapse of 90 minutes. Each measurement value was calculated with use of expression 4 on the basis of a pressure value, a flow rate value, and the effective area of the filtration membrane in the same manner as in the above-described Example 1.

The results of Example 1 are as shown in the table in FIG. 15. The change ratio α 50 minutes after the start of the ozone treatment was smaller than the threshold value α1, i.e., 0.2, and the ozone treatment was completed. At this time, the measurement value had increased from 11 (L/m2/h/kPa) which was an initial measurement value to 33.3 (L/m2/h/kPa). Thus, it can be confirmed that ozone treatment was sufficiently performed and hydrophilization was promoted.

Meanwhile, the results of Comparative Examples 1 and 2 are as shown in the table in FIG. 16. In Comparative Example 1, the measurement value in ozone treatment is 23 (L/m2/h/kPa). Since the measurement value in Example 1 is 33 (L/m2/h/kPa), ozone treatment was stopped while there was room for ozone treatment, in Comparative Example 1.

Meanwhile, in Comparative Example 2, the measurement value is 33.6 (L/m2/h/kPa), and ozone treatment is considered to have been sufficient. However, this measurement value is hardly different from the final measurement value in Example 1 in which ozone treatment was performed for 50 minutes. That is, 50 minutes is sufficient for ozone treatment of the filtration membrane 1 used in the present Example 1 and Comparative Example 2. Thus, performing ozone treatment for 90 minutes as in Comparative Example 2 is uneconomical and inefficient.

As described above, it has been confirmed that: the present filtration membrane treatment method allows finding of a point at which ozone treatment of the filtration membrane is completed; and hydrophilization of the filtration membrane can be assuredly completed by minimum necessary ozone treatment. Judging from the above, the superiority of the present example is obvious.

Although the disclosure is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations to one or more of the embodiments of the disclosure.

It is therefore understood that numerous modifications which have not been exemplified can be devised without departing from the scope of the specification of the present disclosure. For example, at least one of the constituent parts may be modified, added, or eliminated. At least one of the constituent parts mentioned in at least one of the preferred embodiments may be selected and combined with the constituent parts mentioned in another preferred embodiment.

### DESCRIPTION OF THE REFERENCE CHARACTERS

1 filtration membrane

2 accommodating tank

3 first supply portion

30 suction pump

4 liquid

5 first reservoir

50 first reservoir

6 first pump

7 first pipe

8 measurement portion

9 pressure gauge

10 first discharge portion

11 control portion

12 ozone gas generator

13 second pipe

14 second discharge portion

15 adding portion

16 third pipe

17 flowmeter

170 thermometer

18 second supply portion

19 second pump

20 second reservoir

21 fourth pipe

22 valve

23 valve

24 fifth pipe

25 aeration tank

26 active sludge

27 third pump

28 sixth pipe

29 valve

30 suction pump

31 third discharge portion

H measurement value

H′ measurement value

H1 first measurement value

H2 second measurement value

T1 first time period

T2 second time period

1.-12. (canceled)

13. A filtration membrane treatment device which performs ozone treatment on a filtration membrane, the filtration membrane treatment device comprising:
a first supplier which supplies an ozone-containing fluid to the filtration membrane;
a measurementer which measures a measurement value based on a pressure to the filtration membrane, during a supply step of supplying the ozone-containing fluid by the first supplier; and
a controlling circuitry which adjusts, on the basis of a change in the measurement value measured by the measurementer, a supply amount of the ozone-containing fluid to be supplied by the first supplier, wherein
the measurementer measures, as the measurement value, each of a first measurement value H1 after the first supplier supplies the ozone-containing fluid for a first time period and a second measurement value H2 after the supply is performed for a second time period which is longer than the first time period, and
the controlling circuitry
causes the first supplier to continue the supply of the ozone-containing fluid if a change ratio α in the following expression 1 between the first measurement value H1 and the second measurement value H2 is larger than a threshold value α1, and
causes the first supplier to suppress the supply of the ozone-containing fluid if the change ratio α is equal to or smaller than the threshold value α1,

|H1−H2|÷|H1|=α expression 1.

14. A filtration membrane treatment device which performs ozone treatment on a filtration membrane, the filtration membrane treatment device comprising:
a first supplier which supplies an ozone-containing fluid to the filtration membrane;
a second supplier which supplies a measurement fluid which is different from the ozone-containing fluid and from a treatment-target liquid to the filtration membrane,
a measurementer which measures a measurement value based on a pressure to the filtration membrane, during a supply step of supplying the measurement fluid by the second supplier; and
a controlling circuitry which adjusts, on the basis of a change in the measurement value measured by the measurementer, a supply amount of the ozone-containing fluid to be supplied by the first supplier, wherein
at a time of measurement by the measurementer, the controlling circuitry causes the first supplier to stop, causes the second supplier to supply the measurement fluid to the filtration membrane, and causes the measurementer to measure the measurement value,
the measurementer measures, as the measurement value, each of a first measurement value H1, during the supply of the measurement fluid from the second supplier, after the first supplier supplies the ozone-containing fluid for a first time period and a second measurement value H2, during the supply of the measurement fluid from the second supplier, after the first supplier supplies the ozone-containing fluid for a second time period which is longer than the first time period, and
the controlling circuitry
causes the first supplier to continue the supply of the ozone-containing fluid if a change ratio α in the following expression 1 between the first measurement value H1 and the second measurement value H2 is larger than a threshold value α1, and
causes the first supplier to suppress the supply of the ozone-containing fluid if the change ratio α is equal to or smaller than the threshold value α1,
expression 1.

15. The filtration membrane treatment device according to claim 14, wherein
the filtration membrane filters a treatment-target liquid from a primary side to a secondary side, and
the second supplier is configured to either pour the measurement fluid from the secondary side to the primary side of the filtration membrane, or suction or inject the measurement fluid from the primary side to the secondary side of the filtration membrane.

16. The filtration membrane treatment device according to claim 13, wherein
the filtration membrane filters a treatment-target liquid from a primary side to a secondary side, and
the first supplier is configured to either pour the ozone-containing fluid from the secondary side to the primary side of the filtration membrane, or suction or inject the ozone-containing fluid from the primary side to the secondary side of the filtration membrane.

17. The filtration membrane treatment device according to claim 14, wherein
the filtration membrane filters a treatment-target liquid from a primary side to a secondary side, and
the first supplier is configured to either pour the ozone-containing fluid from the secondary side to the primary side of the filtration membrane, or suction or inject the ozone-containing fluid from the primary side to the secondary side of the filtration membrane.

18. The filtration membrane treatment device according to claim 15, wherein
the filtration membrane filters a treatment-target liquid from a primary side to a secondary side, and
the first supplier is configured to either pour the ozone-containing fluid from the secondary side to the primary side of the filtration membrane, or suction or inject the ozone-containing fluid from the primary side to the secondary side of the filtration membrane.

19. The filtration membrane treatment device according to claim 13, wherein the first supplier supplies, as the ozone-containing fluid, at least one of ozone gas, ozone water obtained by dissolving ozone, or ozone-mixed water obtained by mixing, with ozone water, a substance that promotes generation of radicals due to decomposition of ozone.

20. The filtration membrane treatment device according to claim 14, wherein the first supplier supplies, as the ozone-containing fluid, at least one of ozone gas, ozone water obtained by dissolving ozone, or ozone-mixed water obtained by mixing, with ozone water, a substance that promotes generation of radicals due to decomposition of ozone.

21. The filtration membrane treatment device according to claim 15, wherein the first supplier supplies, as the ozone-containing fluid, at least one of ozone gas, ozone water obtained by dissolving ozone, or ozone-mixed water obtained by mixing, with ozone water, a substance that promotes generation of radicals due to decomposition of ozone.

22. The filtration membrane treatment device according to claim 13, wherein
regarding the measurement value from the measurementer,
a pressure value in a pipe through which a fluid being supplied to the filtration membrane is flowing is measured as the measurement value,
a trans-membrane pressure value between inside and outside of the filtration membrane at a time of passage of the fluid through the filtration membrane is measured as the measurement value, or
a ratio between the pressure value or the trans-membrane pressure value and a flow rate value of the fluid being supplied to the filtration membrane is measured as the measurement value.

23. The filtration membrane treatment device according to claim 14, wherein
regarding the measurement value from the measurementer,
a pressure value in a pipe through which a fluid being supplied to the filtration membrane is flowing is measured as the measurement value,
a trans-membrane pressure value between inside and outside of the filtration membrane at a time of passage of the fluid through the filtration membrane is measured as the measurement value, or
a ratio between the pressure value or the trans-membrane pressure value and a flow rate value of the fluid being supplied to the filtration membrane is measured as the measurement value.

24. The filtration membrane treatment device according to claim 15, wherein
regarding the measurement value from the measurementer,
a pressure value in a pipe through which a fluid being supplied to the filtration membrane is flowing is measured as the measurement value,
a trans-membrane pressure value between inside and outside of the filtration membrane at a time of passage of the fluid through the filtration membrane is measured as the measurement value, or
a ratio between the pressure value or the trans-membrane pressure value and a flow rate value of the fluid being supplied to the filtration membrane is measured as the measurement value.

25. The filtration membrane treatment device according to claim 13, wherein
the filtration membrane is formed of a material that is hydrophilized by ozone, and
the controlling circuitry determines a degree of hydrophilization of the filtration membrane on the basis of the change in the measurement value.

26. The filtration membrane treatment device according to claim 14, wherein
the filtration membrane is formed of a material that is hydrophilized by ozone, and
the controlling circuitry determines a degree of hydrophilization of the filtration membrane on the basis of the change in the measurement value.

27. A membrane filtration device which treats a treatment-target liquid with use of the filtration membrane treatment device according to claim 13, the membrane filtration device comprising:
a storage tank which stores the treatment-target liquid and in which the filtration membrane is immersed; and
a transferer which transfers, to outside of the storage tank, the treatment-target liquid having been filtered by the filtration membrane, wherein
the controlling circuitry causes the transferer to stop and causes the first supplier to supply the ozone-containing fluid to the filtration membrane immersed inside the storage tank.

28. A membrane filtration device which treats a treatment-target liquid with use of the filtration membrane treatment device according to claim 14, the membrane filtration device comprising:
a storage tank which stores the treatment-target liquid and in which the filtration membrane is immersed; and
a transferer which transfers, to outside of the storage tank, the treatment-target liquid having been filtered by the filtration membrane, wherein
the controlling circuitry causes the transferer to stop and causes the first supplier to supply the ozone-containing fluid to the filtration membrane immersed inside the storage tank.

29. A filtration membrane treatment method comprising:
a supply step of supplying an ozone-containing fluid to a filtration membrane;
a measurement step of measuring a measurement value based on a pressure to the filtration membrane, during the supply step of supplying the ozone-containing fluid; and
a control step of adjusting a supply amount of the ozone-containing fluid on the basis of a change in the measurement value, wherein
the measurement step includes measuring each of a first measurement value H1 after the ozone-containing fluid is supplied for a first time period and a second measurement value H2 after the supply is performed for a second time period which is longer than the first time period, and
the control step includes:
continuing the supply of the ozone-containing fluid if a change ratio α in the following expression 1 between the first measurement value H1 and the second measurement value H2 is larger than a threshold value α1; and
suppressing the supply of the ozone-containing fluid if the change ratio α is equal to or smaller than the threshold value α1,

|H1−H2|÷|H1|=α expression 1.

30. A filtration membrane treatment method comprising:
a supply step of supplying an ozone-containing fluid to a filtration membrane;
a measurement fluid supply step of supplying a measurement fluid which is different from the ozone-containing fluid and from a treatment-target liquid to the filtration membrane while the supply step is stopped,
a measurement step of measuring a measurement value based on a pressure to the filtration membrane, during the measurement fluid supply step of supplying the measurement fluid, and
a control step of adjusting a supply amount of the ozone-containing fluid on the basis of a change in the measurement value, wherein
the measurement step includes measuring each of a first measurement value H1, during the supply of the measurement fluid, after the ozone-containing fluid is supplied for a first time period and a second measurement value H2, during the supply of the measurement fluid, after the ozone-containing fluid is supplied for a second time period which is longer than the first time period, and
the control step includes
continuing the supply of the ozone-containing fluid if a change ratio α in the following expression 1 between the first measurement value H1 and the second measurement value H2 is larger than a threshold value α1, and
suppressing the supply of the ozone-containing fluid if the change ratio α is equal to or smaller than the threshold value α1,
expression 1.

31. A filtration membrane treatment device which performs ozone treatment on a filtration membrane, the filtration membrane treatment device comprising:
a first supplier which continuously supplies a fixed amount of ozone-containing fluid to the filtration membrane, to perform the ozone treatment;
a pipe which connects the first supplier and the filtration membrane to each other;
a measurementer which measures a pressure in the pipe as a measurement value; and
a controlling circuitry which adjusts the supply of the ozone-containing fluid from the first supplier on the basis of a change in the measurement value measured by the measurementer, wherein
the controlling circuitry
causes the first supplier to continue the supply of the ozone-containing fluid if a change ratio between a first measurement value and a second measurement value measured by the measurementer after the first measurement value is measured is larger than a threshold value, the first measurement value and the second measurement value being measured by the measurementer, and
causes the first supplier to end the supply of the ozone-containing fluid to complete the ozone treatment if the change ratio is equal to or smaller than the threshold value,
the change ratio is a ratio of an absolute value of a difference between the first measurement value and the second measurement value to an absolute value of the first measurement value, and
the first measurement value and the second measurement value are each a pressure at a time of supplying the ozone-containing fluid, tap water, pure water, ultrapure water, an alkaline chemical, or an acidic chemical into the pipe.

32. A filtration membrane treatment method for supplying an ozone-containing fluid from a first supplier through a pipe to a filtration membrane, to perform ozone treatment on the filtration membrane, the filtration membrane treatment method comprising:
a supply step of supplying a fixed amount of ozone-containing fluid from the first supplier to the filtration membrane, to perform the ozone treatment;
a measurement step of measuring a pressure in the pipe as a measurement value; and
a control step of adjusting the supply of the ozone-containing fluid from the first supplier on the basis of a change in the measurement value, wherein
the control step includes
causing the first supplier to continue the supply of the ozone-containing fluid if a change ratio between a first measurement value and a second measurement value measured after the first measurement value is measured is larger than a threshold value, the first measurement value and the second measurement value being measured in the measurement step, and
causing the first supplier to end the supply of the ozone-containing fluid to complete the ozone treatment if the change ratio is equal to or smaller than the threshold value,
the change ratio is a ratio of an absolute value of a difference between the first measurement value and the second measurement value to an absolute value of the first measurement value, and
the first measurement value and the second measurement value are each a pressure at a time of supplying the ozone-containing fluid, tap water, pure water, ultrapure water, an alkaline chemical, or an acidic chemical into the pipe.
